(19) United States
(12) Patent Application Publication
(10) Pub. No.: US 2004/0243036 A1
(43) Pub. Date: Dec. 2, 2004

(54) Kit of massage sheet and self-standing container

(76) Inventors: Hyung Ma Ki, Gyeonggi-do (KR); Sung Lyoul Yong, Seoul (KR); In Sup Dong, Seoul (KR); Young Soo Kim, Gyeonggi-do (KR); Jeong Heun Lee, Seoul (KR)

Correspondence Address: BURNS DOANE SWECKER & MATHIS L L P, POST OFFICE BOX 1404, ALEXANDRIA, VA, 22313-1404, US

(21) Appl. No.: 10/469,042

(22) PCT Filed: Jul. 16, 2003
(86) PCT No.: PCT/KR03/01406

(30) Foreign Application Priority Data
Jul. 16, 2002 (KR) 10-2002-0041837

(51) Int. Cl. A61H 11/00; A61H 7/00

(52) U.S. Cl. 601/135; 601/137

(57) ABSTRACT

A kit of a wraparoundable massage sheet with a plurality of massage protrusions on one side thereof and a self-standing container for use as a massage tool in combination with the massage sheet, the massage sheet having a size and thickness suitable for allowing the massage sheet to be wrapped around said container, the massage protrusions distributed in an area great enough to, when gripped, permit the palm and fingers of a human body to make simultaneous contact with the massage protrusions, the massage protrusions so sized, shaped and arranged that they can apply massage pressure to a multiplicity of discrete, adjoining points of the human body as the container is pressed or tapped against the human body.

### FIELD OF TH INVENTION

The present invention is directed to a massage sheet, and more particularly, to a kit of a massage sheet and a self-standing container wherein a wraparoundable massage sheet with a plurality of massage protrusions on one side thereof is utilized in combination with a self-standing container as a massage tool.

### BACKGROUND ART

It is generally known in the art that massage assists in promoting the circulation of blood and relieving fatigue and can be done by way of kneading, pressing, tapping, rolling specific parts of a human body, including hands and feet, manually or with the use of a massage tool.

A variety of massage tools have been proposed up to now. As an example, U.S. Pat. Nos. 6,551,261 and 6,450,980 and U.S. Design Pat. Nos. 469,879, 468,829 and 435,110 disclose massage tools of striking type; and U.S. Pat. Nos. 6,419,650, 6,245,031, 5,741,219 and 5,458,561 and U.S. Design Pat. Nos. 465,029 and 387,873 teach massage tools of rolling type.

Furthermore, U.S. Pat. Nos. 6,409,690, 5,830,163, 2,820,454, 2,476,921, 2,465,725 and 1,981,379 and U.S. Design Pat. Nos. 475,792, and 471,635 disclose foot massage tools; and U.S. Pat. Nos. 6,487,726 and 6,241,696 and U.S. Design Pat. Nos. 444,883, 412,752 and 403,076 teach pressing type massage tools.

In addition, U.S. Pat. Nos. 6,551,260, 6,494,849, 6,440,092, 6,440,091, and 6,190,339 disclose massage tools operated mechanically.

The massage tools enumerated just above are sold as a product devoted for a specific massage purpose, and therefore the consumers feel burdensome in the standpoint of economy because they have to purchase more than one massage tools depending on the desired use.

The inventors of the instant invention have conceived an idea of providing massage effect by way of attaching a massage tool to the outer circumference of a typical, general purpose container product.

For example, by virtue of attaching a wraparoundable massage sheet of sticker type or label type to a beverage bottle or providing it as a kit with the beverage bottle, it becomes possible for the user to enjoy various kinds of massage such as fingering, pressing, striking, and rolling. Such a massage sheet may be provided to the consumers free of charge by the product maker for the purpose of advertisement or sales promotion, thus removing the need for the consumers to buy the massage sheet together with a container product. This motivated the inventors to conceive the present invention.

Set forth below is the prior art that the inventors are presently aware of and consider pertinent to the subject application.

As is generally known, labels are produced and attached to a product container itself or a package thereof. The major items displayed by the label are a product name and a trademark, and may further include, in order to provide as much information as possible to the consumers, such items as contents, quality, ingredients, the standard of raw material, quantity, production date, manufacturer or distributor, usage, etc. In particular, the trademark plays a key role in permitting the consumesr to visually identify and recognize the source of product and there are many types of trademark display technique developed and adopted thus far.

On the other hand, stickers is made of paper or cellophane on one side of which an advertising paraphrase and telephone number are printed and on the other side of which adhesive is applied to enable the stickers to be attached to a window glass, an article of commerce and a display stand. Such stickers are widely used by fast-food stores, foodstuff delivery stores, video tape rentals, or many other kinds of business entity for the purpose of advertisement.

Japanese Patent Laid-open Publication No. H2-47035 dated Feb. 16, 1990 discloses an in-mold formed label that has letters in the shape of protrusions; Japanese Patent Laid-open Publication No. 2001-192081 dated Jul. 17, 2001 teaches an ampule bottle on the body portion of which a label with brake protrusions is attached in order to repress unwanted rolling movement of the ampule bottle on a tilted surface; and Japanese Patent Laid-open Publication No. H10-275206 dated Oct. 13, 1998 and Japanese Patent Laid-open Publication No. H11-129605 dated May 18, 1999 show a label on which Braille letters are formed to inform a visually handicapped person of the information about commercial products or vending machines.

Korean Design Registration No. 149790 and Korean Utility Model Laid-open Publication No. 94-26707 disclose a glass bottle on the body portion of which a plurality of protruding needles are integrally formed in such an arrangement that, when the glass bottle is gripped, the protruding needles can stimulate the the palm to get the effect of Korean Hand Acupuncture. This prior art glass bottle poses a couple of problems. One is that it is hard to manufacture a mold for forming the glass bottle and the protruding needles as a unit; and the other is that the protruding needles may cause the glass bottle to be broken during the process of delivery or handling of the latter.

Korean Utility Model Registration Nos. 20-0178885, 20-0263987, 20-0271314 and 20-0275397, and Korean Patent Laid-open Publication No. 2002-51809 disclose a computer mouse that a massage pad for providing massage effect is attached on the upper surface or the click buttons thereof.

Korean Utility Model Registration No. 20-0298185 teaches a metallic beverage can on the body portion of which a plurality of protrusions are formed integrally to increase the surface area of the body portion and the thermal conductivity, thereby shortening the cooling time and making the can easy to grip. As an example of similar prior art, U.S. Pat. No. 6,354,458, No. 5,762,230, No. 5,174,469, No. 4,512,490 and No. 3,335,902 disclose a can type container on the body portion of which a plurality of protrusions or beads are formed integrally in an effort to enhance the gripping power and display a variety of letters to communicate messages to the consumers.

In case of the can type container referred to just above, there is a difficulty in printing letter messages mainly because the protrusions are formed integrally with the body portion of the can. In other words, the protrusions formed on the body portion of the beverage can make it hard to print letters on the body portion, and the printed letters cannot be clearly identified due to the uneven surface of the protrusions.

### SUMMARY OF THE INVENTION

With the shortcomings inherent in the afore-mentioned prior art in mind, it is an object of the present invention to provide a kit of a massage sheet and a self-standing container that makes it possible to use a separate massage sheet in combination with a product container, including a bottle and a can, thus assuring that the combined massage sheet and container can be used as a massage tool for kneading, scrubbing, rolling and striking a specific part of a human body to thereby provide such massage effects as improved blood circulation, relaxation of muscles and Korean traditional hand acupuncture.

Another object of the invention is to provide a kit of a massage sheet and a self-standing container that helps increase the utility value of a product container by way of allowing a printed massage sheet to be used as an advertising sticker or label.

A further object of the invention is to provide a kit of a massage sheet and a self-standing container that can increase the utility value of a product container by making the container reusable as a massage tool during and after its original use and eliminating the need to buy a separate massage tool.

A still further object of the invention is to provide a kit of a massage sheet and a self-standing container that can attract visual interest of the consumer on the appearance of a product container by attaching a massage sheet with massage protrusions over the label of the container in such a fashion as to create cubic and crystal effects.

A yet still further object of the invention is to to provide a kit of a massage sheet and a self-standing container that makes it possible to have a massage sheet hung on the neck portion of a self-standing container, thus providing a point-of-purchase advertisement effect.

According to one aspect of the invention, there is provided a kit of a wraparoundable massage sheet with a plurality of massage protrusions on one side thereof and a self-standing container for use as a massage tool in combination with the massage sheet, wherein the wraparoundable massage sheet has a size and thickness suitable for allowing the massage sheet to be wrapped around the self-standing container, the massage protrusions are distributed in an area great enough to, when gripped, permit a palm and fingers of a human body to make simultaneous contact with the massage protrusions, and the massage protrusions are so sized, shaped, and arranged that they can apply massage pressure to a multiplicity of discrete and adjoining points on the human body as the self-standing container is pressed against the human body.

According to another aspect of the invention, there is provided a kit of a massage sleeve with a plurality of massage protrusions on one side thereof and a self-standing container for use as a massage tool in combination with the massage sheet, wherein the massage sleeve has a size and thickness suitable for allowing the massage sleeve to be fitted on an outer circumference of the self-standing container, the massage protrusions are distributed in an area great enough to, when gripped, permit a palm and fingers of a human body to make simultaneous contact with the massage protrusions, and the massage protrusions are so sized, shaped, and arranged that they can apply massage pressure to a multiplicity of discrete and adjoining points on the human body as the self-standing container is pressed or tapped against the human body.

### BRIEF DESCRIPTION OF THE DRAWINGS

FIG. 1 is a perspective view showing a kit of a massage sheet and a glass bottle type self-standing container according to the first embodiment of the present invention;

FIG. 2 is a cross sectional view of the massage sheet employed in the present invention;

FIG. 3 is a cross sectional view showing a modification of the massage sheet employed in the present invention;

FIGS. 4a, 4b and 4c are perspective views of the massage sheet that illustrate various modifications of the massage protrusions formed on the massage sheet;

FIG. 5 is a perspective view showing a modified kit of a massage sheet and a self-standing container according to the present invention;

FIG. 6 is a perspective view depicting a modification of the massage sheet which has massage protrusions of a particular design;

FIG. 7 is a perspective view showing another modification of the massage sheet employed in the present invention;

FIG. 8 is a perspective view showing a kit of a massage sheet and a plastic self-standing container according to the present invention;

FIG. 9 is a perspective view showing a kit of a massage sheet and a metallic can type self-standing container according to the present invention;

FIG. 10 is a perspective view showing a kit of a massage sheet and a paper-made self-standing container according to the present invention;

FIGS. 11a and 11b are perspective views illustrating a kit of a massage sleeve and a plastic self-standing container according to the second embodiment of the present invention; and

FIG. 12 is a perspective view showing a modification of the massage sleeve employed in the second embodiment of the present invention.

### BEST MODE FOR CARRYING OUT THE INVENTION

A number of preferred embodiments of the present invention will now be described with reference to the accompanying drawings.

It should be appreciated that the terms or words used in the specification and the claims shall not be interpreted in their general meanings but construed in exact conformity with the concept and spirit of the invention as defined in the claims.

The embodiments shown and described herein are nothing more than an example of the present invention and do not stand for the overall technical idea of the present invention in an exhaustive manner, meaning that various changes and modifications may be made without departing from the scope of the invention set forth in the claims.

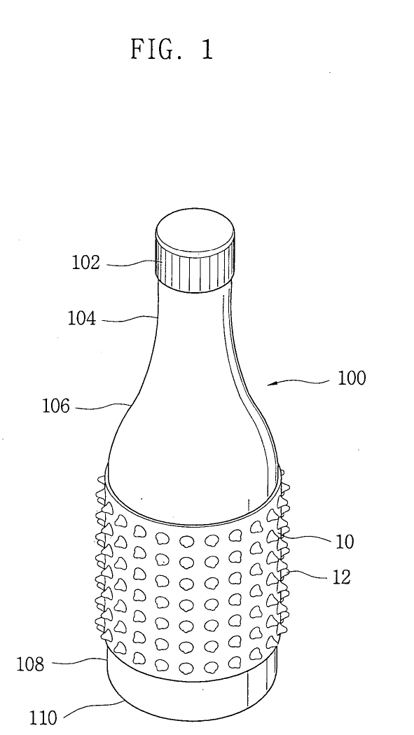

Referring now to FIG. 1 there is shown a kit of a massage sheet and a glass bottle type self-standing container according to the first embodiment of the invention, wherein the term “self-standing” means that the container can stand upright on a plain surface.

As shown, a massage sheet 10 is provided with a plurality of massage protrusions 12 on one side thereof and a glass beverage bottle 100 is used as a massage tool to which the massage sheet 10 is attached.

The glass beverage bottle 100 is of generally used type and is comprised of a stopple 102, a neck portion 104, a shoulder portion 106, a body portion 108 and a bottom portion 110. A label indicating the nature of product is attached to the body portion 108 for the sales purpose. Such a kit of the massage sheet 10 and the glass bottle 100 can be used as a massage tool.

The massage sheet 10 is of wraparoundable type and has a size and thickness suitable for wrapping around the body portion 108 of the glass bottle.

This wraparoundable massage sheet 12 is referred to as massage sheet hereinbelow for the sake of simplicity.

The massage protrusions 12 are distributed over an area great enough to allow simultaneous contact of the fingers and palm of a human body and are so sized, shaped, and arranged as to apply massage pressure on a multiplicity of discrete and adjoining points of the user's skin.

The massage sheet 10 with these massage protrusions 12 is made of synthetic resin, and if required, may be made of a thin metallic plate such as aluminum or stainless steel. The thickness of the massage sheet 10 is preferably 0.05 mm through 0.6 mm. If the massage sheet 10 is thicker than 0.6 mm, it becomes difficult to wrap the massage sheet 10 around the body portion 108 of the glass bottle 100 and the cost of production increases in proportion. If the massage sheet 10 is thinner than 0.05 mm, the massage protrusions 12 tends to be deformed when pressed and therefore cannot provide the intended massage effect.

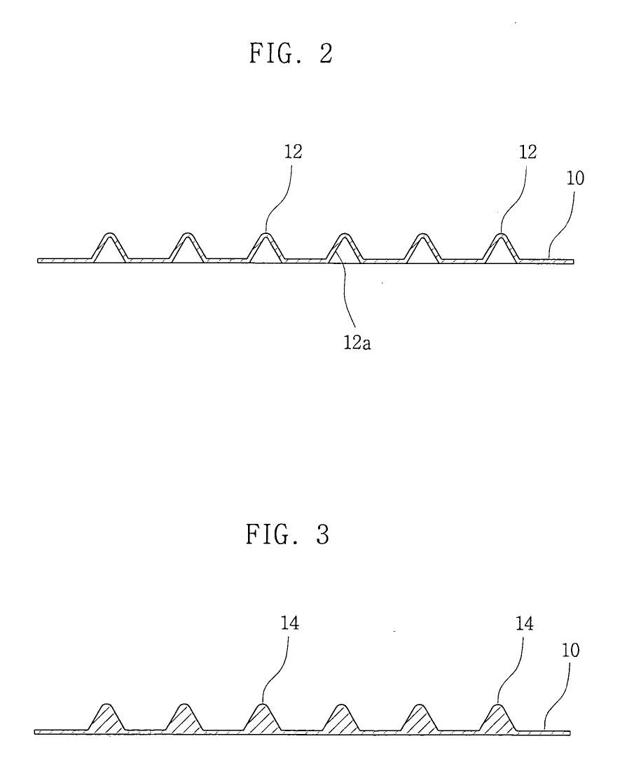

As illustrated in FIG. 2, the massage protrusions 12 are formed integrally with the massage sheet 10 and with the same thickness as that of the massage sheet 10 so that each of the massage protrusions 12 can have a void space 12a therein. The void space 12a in the massage protrusions 12 serves to provide a cushion effect against the external force during the course of massage, making the user feel comfort.

In the meantime, as shown in FIG. 3, the massage sheet 10 can be so formed that the inner space of the protrusions 14 becomes solid. This allows the massage sheet 10 to be formed extremely thin without sacrificing the massage effect.

The massage sheet 10 is attached to the glass bottle 100 with the use of repositionable adhesive, which can be applied on the body portion 108 of the glass bottle 100 or the rear side of the massage sheet 10.

In case the massage sheet 10 is provided as a kit with a plastic container, the massage sheet 10 can be attached to the outer circumference of the body portion of the plastic container by fusion welding through the use of electromagnetic wave, e.g., high-frequency or low-frequency heating.

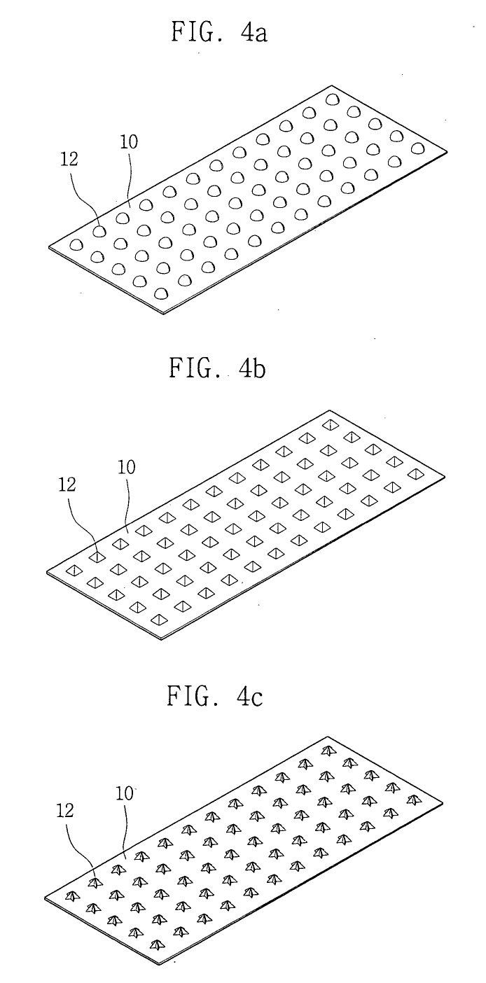

Although the massage protrusions 12 and 14 are shown to have a conical shape in FIGS. 1 through 3, the shape of the massage protrusions 12 may be one of a hemisphere, a pyramid, a sharpened star, etc., as shown in FIGS. 4a, 4b and 4c.

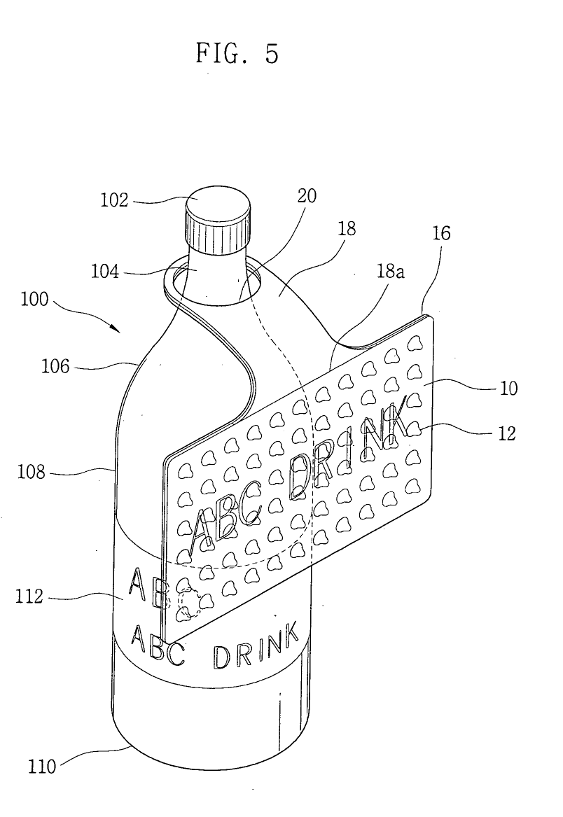

FIG. 5 shows a modification of the kit of a massage sheet and a self-standing container. An adhesive layer (not shown) is provided on the rear side of the massage sheet 10 and is covered with a release back-up sheet 16. Use of the repositionable adhesive makes it possible to detach and relocate the massage sheet 10.

The massage sheet 10 is formed with a hanger hole 20 on the extension portion thereof so that the massage sheet 10 can be hung on the neck portion 104 of the glass bottle 100. This assures that the glass bottle 100 can be displayed on a market display stand while the massage sheet 10 is hung on the neck portion 104 of the glass bottle 100. Thus, the consumer who will buy the displayed glass bottle product can remove the release back-up sheet 16 out of the massage sheet 10 and then attach the massage sheet 10 to the outer circumference of the body portion 108, having a label 112, of the glass bottle 100 so as to use the glass bottle as a massage tool.

Meanwhile, it is desirable that a cutting line 18a is formed on the lower part of the extension portion 18 of the massage sheet 10 so that the massage sheet 10 formed with the massage protrusions 12 can be readily detached from the release back-up sheet 16 along the cutting line 18a. The extension portion 18 is formed of the release back-up sheet 16 alone, not the massage sheet 10.

In the event that the massage sheet 10 is hung on the neck portion 104 of the glass bottle 100 and displayed on the display stand as illustrated above, there may be such instances that the consumer fails to read the label 112 of the product because the label 112 is hidden by the massage sheet 10. Taking this situation into account, it is possible or desirable to provide the massage sheet 10 with a print portion similar to the label 112.

More specifically, assuming that the label 112 of the glass bottle 100 is printed with the name of product ‘ABC DRINK’ as shown in FIG. 5, the same or similar letters can be printed on the massage sheet 10 in order to overcome the situation that the label 112 is hidden by the massage sheet 10 and becomes out of sight of the consumers. This provides an additional effect of attracting the attention of the consumers.

Furthermore, the massage sheet 10 can be used as an advertising sticker or label by printing the letters ‘ABC DRINK’ or ‘Enjoy Bottle Massage’ thereon, for instance. In case of the massage sheet 10 with the release back-up sheet 16, the letters may be printed on the surface of the release back-up sheet 16 instead of the massage sheet 10.

Although the massage sheet 10 may made of opaque material, it is preferable that the massage sheet 10 is made of transparent material so that the label 112 on the glass bottle itself can be seen from the outside even when the massage sheet 10 is hung on the glass bottle 100. If desired, the transparent massage sheet 10 may be colored.

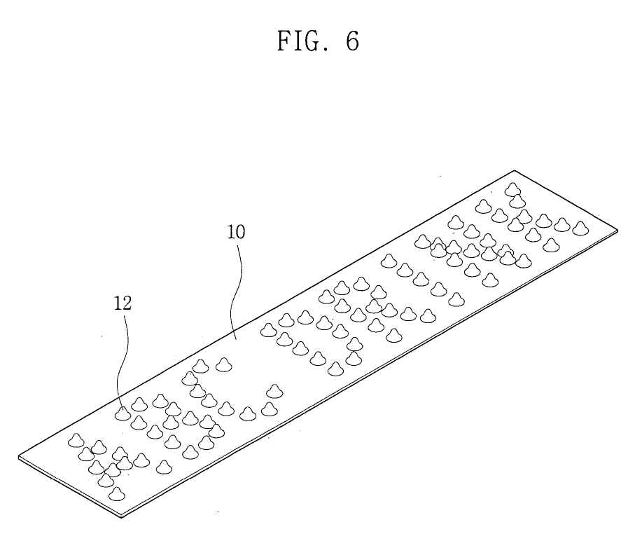

FIG. 6 shows a modification of the massage sheet which has massage protrusions of a particular design arrangement. As shown, a plurality of massage protrusions 12 is arranged on the massage sheet 10 to form a letter design ‘ABC DRINK’.

Besides the letter design illustrated, the massage protrusions 12 can be arranged to present designs of a heart, a diamond, other diagrams, symbols and marks, which would help induce special interest of the consumers on the appearance of the product and enhance the advertising effect of the product itself.

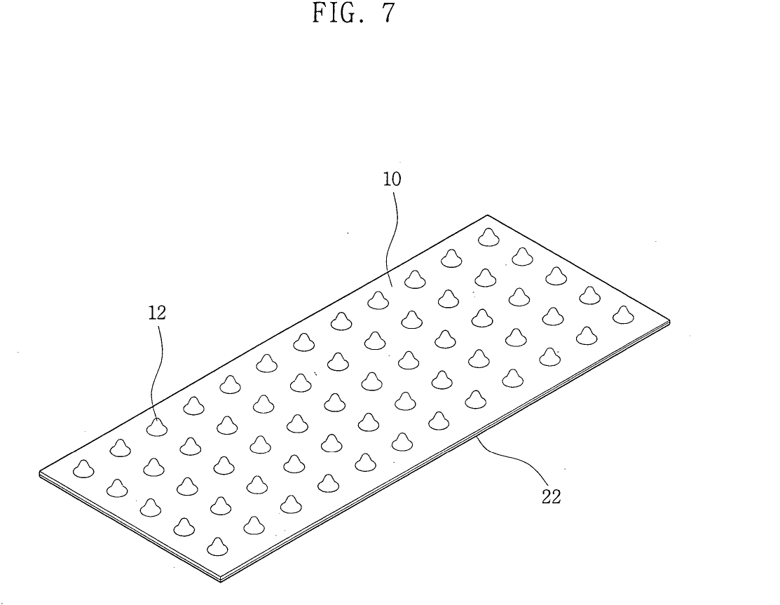

FIG. 7 shows another modification of the massage sheet employed in the present invention. As shown, the massage sheet 10 is formed with a plurality of massage protrusions 12 on one side thereof and has a magnetic rubber base 22 on the other side which enables the massage sheet 10 to be attached to the self-standing container through the magnetic force. The self-standing container is made of a metallic can in this case. It would be preferred that the massage sheet 10 is attached to the fill circumference of the can if the can is of circular cross section, and to one flat side of the can if the cross section of the can is rectangular or polygonal.

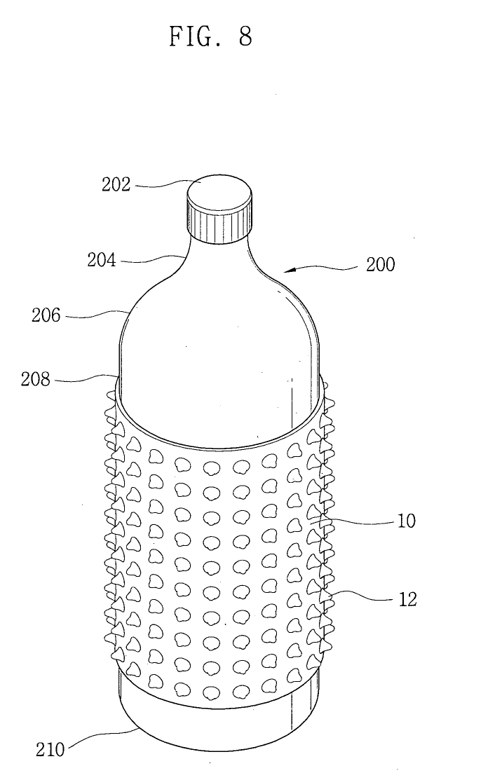

FIG. 8 shows a kit of a massage sheet and a self-standing plastic container.

As shown, a massage sheet 10 with a plurality of massage protrusions 12 on one side thereof is wrapped around a plastic container 200 for use as a massage tool.

The plastic container 200 is a widely used beverage bottle and consists of a stopple or cap 202, a neck portion 204, a shoulder portion 206, a body portion 208 and a bottom portion 210. A label (not shown) is attached to the body portion 108 or the shoulder portion 206. The kit of the massage sheet 10 and the plastic container 200 is sold to the consumers so that they can directly use the kit as a massage tool.

Alternatively, as illustrated in FIG. 5, the plastic container 200 can be displayed on a market display stand while the massage sheet 10 is hung on the neck portion 204 of the container 200. Thus, the consumer who will buy the displayed container can remove the release back-up sheet 16 out of the massage sheet 10 and then attach the massage sheet 10 to the outer circumference of the body portion 208 so as to use the plastic container as a massage tool.

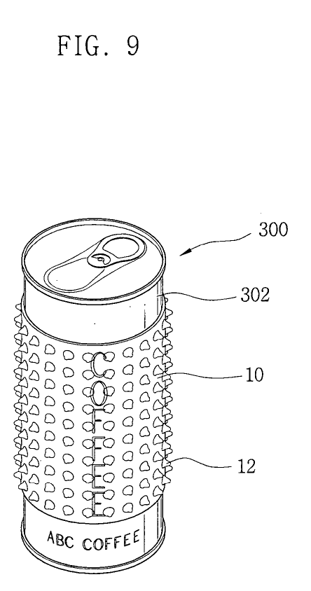

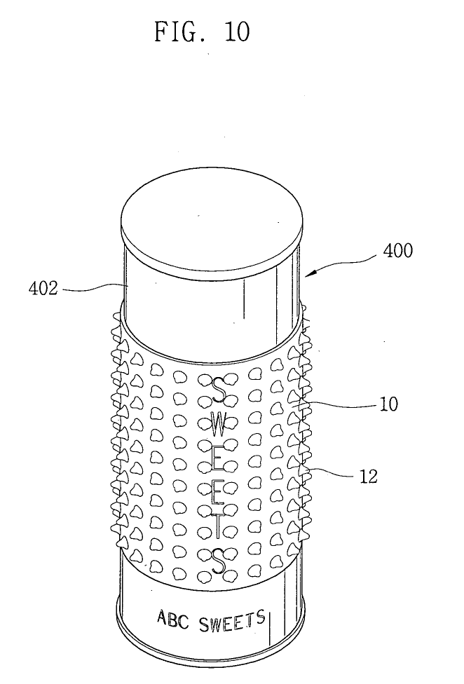

FIG. 9 shows a kit of a massage sheet and a metallic can according to the present invention. As shown, a massage sheet 10 with a plurality of massage protrusions 12 on one side thereof is attached to the outer circumference of the body portion 302 of the metallic can 300 so as to enable the consumers to use the can as a massage tool. The metallic can 300 is the one generally used for containing beverage and has a printed label on the body portion 302 thereof. The kit of the massage sheet 10 and the metallic can 300 is sold in such a state that the consumers can use it as a massage tool directly.

In case of the metallic can 300 to which the massage sheet 10 is attached, it would be preferable that the massage sheet 10 is made of transparent material so that the label letters, e.g., ‘COFFEE’, printed on the metallic can 300 can be seen through the massage sheet 10 as shown in FIG. 9.

Moreover, this type of metallic can 300 with the massage sheet 10 helps ensure that the heat transfer between the can and the hand is suppressed by the massage sheet 10, thus making the user feel confortable in gripping hot or cold cans containing, e.g., coffee and black tea. This holds true in case of the glass bottle 100 and the plastic container 200 set forth hereinabove.

If the massage sheet 10 is made of colorless transparent material or colored transparent material in case of the can 300, the massage protrusions 12 give rise to light dispersion under the solar light or artificial illumination environment, which leads to a crystal effect or other visual advertising effect that distinguishes the inventive can product from other ones.

In addition, most of the commercially available cans are printed with a label on the body portion 302 thereof and the consumers can recognize the content displayed on the label with ease through the transparent massage sheet 10 even after the massage sheet 10 is attached to the can 300.

FIG. 10 shows a kit of a massage sheet and a paper container according to the invention. As shown, a massage sheet 10 with a plurality of massage protrusions 12 on one side thereof is attached to the outer circumference of the body portion 402 of the paper container 400 so as to enable the consumers to use the can as a massage tool. The body portion 402 of the paper container 400 preferably has the thickness great enough not to be deformed by the massage pressure.

In case of the paper container 400 to which the massage sheet 10 is attached, the massage sheet 10 is preferably made of transparent material so that a label, e.g., ‘SWEETS’ printed on the paper container 400 itself can be seen through the massage sheet 10.

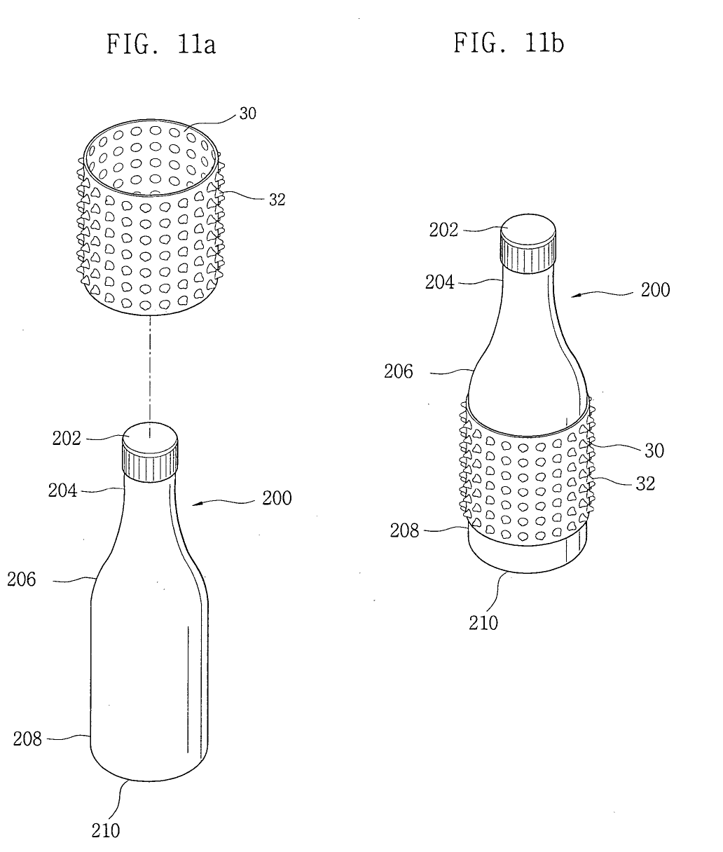

FIGS. 11a and 11b show a kit of a massage sleeve and a self-standing container according to the second of the present invention. As shown, This kit comprises a closed loop type massage sleeve 30 with a plurality of massage protrusions 12 on one side thereof and a plastic self-standing container 200 suitable for use as a massage tool, to which the massage sleeve 10 is attached.

The massage sleeve 30 has such a size and thickness that it can be coupled on the outer circumference of the body portion 208 of the plastic container 200, whereas the massage protrusions 32 are so sized, shaped and arranged that they can make simultaneous contact with the fingers and palm of a human body to apply massage pressure to a multiplicity of discrete and adjoining points on the human body as the container is pressed or tapped against the latter. The massage sleeve 30 of the construction noted above is preferably made of heat-shrinkable synthetic resin and is attached to the body portion 208 of the plastic container 200.

As shown in FIG. 11b, the massage sleeve 30, having a diameter a little larger than that of the body portion 208 of the plastic container 200, is coupled on the body portion 208 of the container 200 and then heated to shrink, thereby assuring that the massage sleeve 30 can be secured tightly to the body portion 208 of the plastic container 200. Alternatively, the massage sleeve 30 may be manufactured with heat-shrinkable synthetic resin of such property that, when exposed to air, tends to shrink by itself. The container employed in this kit is not limited to the plastic container 200 but may comprise a glass bottle and a metallic can.

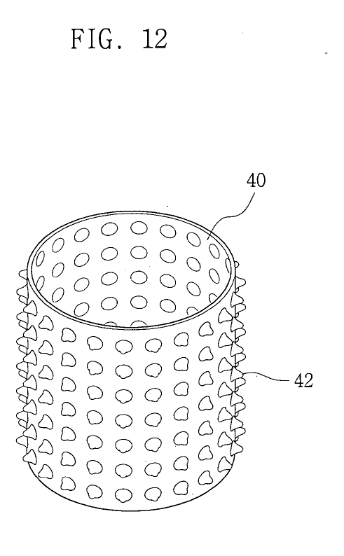

FIG. 12 shows a modification of the massage sleeve used in the kit of the present invention. As shown, the massage sleeve 40 is formed with a plurality of massage protrusions 42 on one side thereof and is made of elastically deformable material. The elastic band type massage sleeve 40 can be elastically enlarged and attached to the outer circumference of the body portion of the self-standing container such as a glass bottle, a plastic container, a metallic can and a paper container.

As with the massage sheet 10 according to the first embodiment, the massage sleeve 30 of the second embodiment may have a specific print portion so that it can serve as a label of the self-standing container.

The massage protrusions 32 are formed integrally with the massage sleeve 30 and with the same thickness as the massage sleeve 30. There is provided a void space in the respective massage protrusion 32 so as to have a cushion effect against the massage pressure.

Although the massage protrusions 32 have been shown to have the shape of a cone, it would be equally possible to form the massage protrusions 32 in the configuration of a hemisphere, a pyramid, a star and so on. Also, the massage sleeve 30 may be made of transparent or opaque synthetic resin which is colored or colorless. Moreover, the massage protrusions 32 are arranged and formed into a particular design of characters, letters, diagrams, symbols or marks. The thickness of the massage sleeve 30 is preferably 0.05 mm to 0.6 mm to ensure that the massage protrusions 32 are not deformed by the massage pressure.

It should be appreciated that the massage sheet 10 illustrated above can be wrapped around either the overall area or a partial area of the outer circumference of the body portion 108, 208, 302 or 402 of the glass bottle 100, the plastic container 200, the metallic can 300 and the paper container 400, depending on the size or outer appearance of the containers. Furthermore, although the massage sheet 10 illustrated above has a rectangular shape, it would be possible to change the shape of the massage sheet 10 without adversely affecting the essential function of the self-standing container as a massage tool.

The massage sheet 10 can be manufactured and distributed in the form of a strip, a roll or a stack and, in an automatic production line of, e.g., a beverage company, the massage sheet 10 can be fed continuously so that it can be automatically attached to the outer circumference of the self-standing container.

Examples of the glass bottle 100 to which the massage sheet 10 or the massage sleeve 30 or 40 can be attached include a beverage bottle, a wine bottle, a beer bottle, a medicine bottle, a cosmetics bottle, a foodstuff bottle, etc. A bottle with a volume of less than 1,000 ml is convenient to use as a massage tool. Particularly, a bottle of which volume is 100 ml or so, for instance, a health care beverage bottle or a medicine bottle is easy to grip, convenient to carry and usable as a massage tool for pressing a local skin area.

Examples of the plastic container 200 to which the massage sheet 10 or the massage sleeve 30 or 40 can be attached comprise a beverage container, a mineral water container, a wine container, a beer container, a medicine container and a foodstuff container. A container with a volume of less than 2,000 ml is convenient to use as a massage tool and, particularly, a medicine container of which volume is 150 ml or so is easy to grip, convenient to carry and usable as a massage tool for pressing a local skin area.

Examples of the metallic can 300 to which the massage sheet 10 or the massage sleeve 30 or 40 can be attached include a beverage can, a beer can, a foodstuff can and even a plastic can recently available.

A cookie container of cylindrical shape is an example of the paper container 400 to which the massage sheet 10 or the massage sleeve 30 or 40 can be attached.

### INDUSTRIAL APPLICABILITY

The inventive kit of a massage sheet and a self-standing container described hereinabove has the following advantages.

First of all, thanks to the fact that the massage sheet with the massage protrusions is provided together with a self-standing container as a kit either in the attached state or separately, the consumer who will buy the container can use it as a massage tool during or after drinking the beverage contained therein. Such massage effects as improved blood circulation, relaxation of muscles and Korean traditional hand acupuncture can be attained by way of pressing, scrubbing, rolling and striking the container against the human body. This helps reduce the economical burden that the consumers should otherwise bear in case of purchasing a devoted massage tool.

Furthermore, the crystal ornament effect of a container can be achieved by the light dispersing action of the massage protrusions, and the three-dimensional visual effect can be provided by attaching a transparent colored or colorless massage sheet over the label on the container. It also be possible to provide a point-of-purchase advertisement effect by displaying a container with a massage sheet hung on the neck portion thereof. This will induce interest of the consumers and assists in sales promotion of the container.

Although certain preferred embodiments of the present invention have been described, it will be understood by those skilled in the art that various changes and modifications can be made within the spirit and scope of the present invention.

What is claimed is:

1. A kit of a wraparoundable massage sheet with a plurality of massage protrusions on one side thereof and a self-standing container for use as a massage tool in combination with the massage sheet,
wherein the wraparoundable massage sheet has a size and thickness suitable for allowing the massage sheet to be wrapped around the self-standing container,
the massage protrusions are distributed in an area great enough to, when gripped, permit a palm and fingers of a human body to make simultaneous contact with the massage protrusions, and
the massage protrusions are so sized, shaped, and arranged that they can apply massage pressure to a multiplicity of discrete and adjoining points on the human body as the self-standing container is pressed against the human body.

2. The kit as recited in claim 1, further comprising an adhesive layer provided on the other side of the wraparoundable massage sheet.

3. The kit as recited in claim 1, further comprising an adhesive layer provided on the other side of the wraparoundable massage sheet and a release back-up sheet for protecting the adhesive layer.

4. The kit as recited in claim 1, wherein the self-standing massage sheet is attached on an outer surface of a body portion of the self-standing container by electromagnetic wave heating.

5. The kit as recited in claim 1, wherein the wraparoundable massage sheet includes a print portion with a preselected design and is utilizable as an advertising sticker.

6. The kit as recited in claim 3, wherein the wraparoundable massage sheet includes a print portion with a preselected design and is utilizable as an advertising sticker.

7. The kit as recited in claim 1, wherein the wraparoundable massage sheet includes a print portion with a preselected design and is utilizable as a label.

8. The kit as recited in claim 1, wherein the wraparoundable massage sheet is formed with a magnetic base on the other side thereof, the magnetic base attachable to the self-standing container by a magnetic force.

9. The kit as recited in claim 1, wherein the massage protrusions are formed integrally with the massage sheet.

10. The kit as recited in claim 9, wherein the massage protrusions has the same thickness as the thickness of the massage sheet, and a void space is provided in each of the massage protrusions so as to provide a cushion effect against the massage pressure.

11. The kit as recited in claim 9, wherein the massage protrusions are solid.

12. The kit as recited in claim 1, wherein the massage protrusions has a shape selected from the group consisting of a hemisphere, a cone, a pyramid and a star.

13. The kit as recited in claim 1, wherein the wraparoundable massage sheet is made of transparent material.

14. The kit as recited in claim 1, wherein the wraparoundable massage sheet is made of opaque material.

15. The kit as recited in claim 1, wherein the massage protrusions are formed and arranged in the form of a character, a diagram, a symbol and a mark.

16. The kit as recited in claim 1, wherein the wraparoundable massage sheet is made of synthetic resin.

17. The kit as recited in claim 1, wherein the wraparoundable massage sheet is made of a metal plate.

18. The kit as recited in claim 1, wherein the wraparoundable massage sheet has a thickness of 0.05 mm to 0.6 mm.

19. The kit as recited in claim 3, wherein the wraparoundable massage sheet has an extension portion formed with a hanger hole removably engageable with a neck portion of the self-standing container.

20. The kit as recited in claim 1, wherein the self-standing container is a glass bottle.

21. The kit as recited in claim 3, wherein the self-standing container is a glass bottle.

22. The kit as recited in claim 1, wherein the self-standing container is a plastic container.

23. The kit as recited in claim 3, wherein the self-standing container is a plastic container.

24. The kit as recited in claim 1, wherein the self-standing container is a metal can.

25. The kit as recited in claim 3, wherein the self-standing container is a metal can.

26. The kit as recited in claim 1, wherein the self-standing container is a paper container.

27. The kit as recited in claim 3, wherein the self-standing container is a paper container.

28. A kit of a massage sleeve with a plurality of massage protrusions on one side thereof and a self-standing container for use as a massage tool in combination with the massage sheet,
wherein the massage sleeve has a size and thickness suitable for allowing the massage sleeve to be fitted on an outer circumference of the self-standing container,
the massage protrusions are distributed in an area great enough to, when gripped, permit a palm and fingers of a human body to make simultaneous contact with the massage protrusions, and
the massage protrusions are so sized, shaped, and arranged that they can apply massage pressure to a multiplicity of discrete and adjoining points on the human body as the self-standing container is pressed or tapped against the human body.

29. The kit as recited in claim 28, wherein the massage sleeve is made of heat-shrinkable synthetic resin and is attachable to a body portion of the self-standing container.

30. The kit as recited in claim 28, wherein the massage sleeve is made of elastically deformable material and is elastically attachable to a body portion of the self-standing container.

31. The kit as recited in claim 28, wherein the self-standing container is a glass bottle.

32. The kit as recited in claim 28, wherein the self-standing container is a plastic container.

33. The kit as recited in claim 28, wherein the self-standing container is a metal can.

34. The kit as recited in claim 28, wherein the massage sleeve includes a print portion with a preselected design and is utilizable as a label.

35. The kit as recited in claim 28, wherein the massage sleeve has a thickness of 0.05 mm to 0.6 mm.
